(19) United States
(12) Patent Application Publication
(10) Pub. No.: US 2026/0228205 A1
(43) Pub. Date: Aug. 6, 2026

(54) DATA PROCESSING METHOD AND APPARATUS, ELECTRONIC DEVICE, AND STORAGE MEDIUM

(71) Applicant: CLOUD INTELLIGENCE ASSETS HOLDING (SINGAPORE) PRIVATE LIMITED, Singapore (SG)

(72) Inventors: Gang HUANG, Beijing (CN); Qingjie ZHAO, Beijing (CN); Jie CHEN, Shenzhen, Guangdong (CN); Tianlong WU, Hangzhou, Zhejiang (CN); Senfan WU, Hangzhou, Zhejiang (CN); Jun WANG, Hangzhou, Zhejiang (CN); Xiaoxiao WANG, Beijing (CN); Chenhao KONG, Hangzhou, Zhejiang (CN)

(21) Appl. No.: 19/149,834

(22) PCT Filed: Apr. 11, 2024
(86) PCT No.: PCT/CN2024/087136

§ 371 Date: Jul. 21, 2025

(30) Foreign Application Priority Data
Apr. 13, 2023 (CN) 202310411834.0

(51) Int. Cl. G06F 16/23

(52) U.S. Cl. CPC G06F 16/2336

(57) ABSTRACT

The present disclosure relates to the field of cloud computing technologies, and provides a data processing method, an apparatus, an electronic device, and a storage medium. The data processing method includes that: at least one new function instance is created in response to a number of concurrent service requests processed by existing function instances exceeding a concurrency threshold, but not exceeding a concurrency limit of each function instance configured in advance, where the concurrency threshold changes dynamically based on service runtime state information; and the at least one new function instance is activated to process received service requests in response to the number of concurrent service requests exceeding the concurrency limit of each function instance.

The present disclosure claims priority to Chinese Patent Application No. 202310411834.0, filed to China National Intellectual Property Administration on Apr. 13, 2023 and titled “DATA PROCESSING METHOD AND APPARATUS, ELECTRONIC DEVICE, AND STORAGE MEDIUM”, the content of which is hereby incorporated by reference in its entirety.

### TECHNICAL FIELD

The present disclosure relates to the field of cloud computing technologies, and in particular, to a data processing method, an apparatus, an electronic device, and a storage medium.

### BACKGROUND OF THE INVENTION

A serverless platform is a platform where management services are provided by a third party and computing services are provided for users through function instances. When the users benefit from the maintenance-free elastic scaling capability of the serverless platform, traffic fluctuations may cause cold start issues of function instances. Especially for online service scenarios, it is difficult for the users to accept the delay caused by the cold start, and it is expected that the serverless platform can maintain a stable end-to-end delay as services grow.

With the development of service functions, function initialization logic becomes more complex and a function image or code package becomes larger, which means a slower cold start speed. In general, to completely eliminate cold starts for online services on the serverless platform, a large number of redundant resident reserved function instances can be configured. On the one hand, this method is not user-friendly, and may cause a lot of waste of computing resources and cause the users to bear high costs. On the other hand, for unexpected traffic growth, delays caused by cold starts of a large number of function instances may occur, affecting service quality.

### SUMMARY OF THE INVENTION

Embodiments of the present disclosure provide a data processing method, an apparatus, an electronic device, and a storage medium, to avoid increasing user costs and reduce a delay caused by a cold start of a function instance.

According to a first aspect, some embodiments of the present disclosure provide a data processing method. The data processing method includes that:
at least one new function instance is created in response to a number of concurrent service requests processed by existing function instances exceeding a concurrency threshold, but not exceeding a concurrency limit of each function instance configured in advance, where the concurrency threshold changes dynamically based on service runtime state information; and the at least one new function instance is activated to process received service requests in response to the number of concurrent service requests exceeding the concurrency limit of each function instance.

According to a second aspect, some embodiments of the present disclosure provide a data processing apparatus. The apparatus includes:
a creating module, configured to create at least one new function instance in response to a number of concurrent service requests processed by existing function instances exceeding a concurrency threshold, but not exceeding a concurrency limit of each function instance configured in advance, where the concurrency threshold changes dynamically based on service runtime state information; and a processing module, configured to activate the at least one new function instance to process received service requests in response to the number of concurrent service requests exceeding the concurrency limit of each function instance.

According to a third aspect, some embodiments of the present disclosure provide an electronic device, including a memory, a processor, and a computer program stored in the memory. The processor implements any one of the above methods when executing the computer program.

According to a fourth aspect, some embodiments of the present disclosure provide a computer-readable storage medium. The computer-readable storage medium stores a computer program. The computer program, when executed by a processor, implements any one of the above methods.

Compared with the related art, the present disclosure has the following advantages.

The present disclosure provides the data processing method, the apparatus, the electronic device, and the storage medium. First, the at least one new function instance is created in response to a number of concurrent service requests processed by existing function instances exceeding a concurrency threshold, but not exceeding a concurrency limit of each function instance configured in advance, where the concurrency threshold changes dynamically based on service runtime state information. Then the at least one new function instance is activated to process received service requests in response to the number of concurrent service requests exceeding the concurrency limit of each function instance. In the embodiments of the present disclosure, when the number of concurrent service requests processed by the existing function instances exceeds the concurrency threshold, the at least one new function instance is created, thereby reducing delay caused by cold start of the function instances. The at least one new function instance is not activated immediately once the at least one new function instance has been created, but is activated when the number of concurrent service requests exceeds the concurrency limit of each function instance configured in advance, so as to avoid waste of resources and prevent additional costs for users.

The above description is an overview of the technical solution of the present disclosure. In order to have a clearer understanding of the technical means of the present disclosure, implementation may be performed in accordance with the contents of the specification, and in order to make the above and other purposes, characteristics and advantages of the present disclosure more clearly understood, the following are specific implementations of the present disclosure.

### BRIEF DESCRIPTION OF DRAWINGS

In the accompanying drawings, unless otherwise specified, the same reference numerals throughout multiple figures represent the same or similar components or elements. The accompanying drawings are not necessarily drawn to scale. It should be understood that the accompanying drawings illustrate some implementations according to the present disclosure, and should not be construed as a limitation on the scope of the present disclosure.

FIG. 1 is a schematic diagram of an application scenario according to the present disclosure.

FIG. 2 is a flowchart of a data processing method according to some embodiments of the present disclosure.

FIG. 3 is a schematic diagram of downscaling function instances according to some embodiments of the present disclosure.

FIG. 4 is a structural block diagram of a data processing apparatus according to some embodiments of the present disclosure.

FIG. 5 is a block diagram of an electronic device for implementing some embodiments of the present disclosure.

### DETAILED DESCRIPTION OF THE INVENTION

Some exemplary embodiments are briefly described below. As a person having ordinary skill in the art may realize that the described embodiments may be modified in various different manners without departing from the conception or the scope of the present disclosure. Therefore, the accompanying drawings and the description are to be considered illustrative in nature but not restrictive.

In order to facilitate understanding of the technical solutions of the embodiments of the present disclosure, related technologies of the embodiments of the present disclosure are described below. As an optional solution, the following related art may be arbitrarily combined with the technical solutions of the embodiments of the present disclosure, and all fall within the protection scope of the embodiments of the present disclosure.

It should be noted that user information (including but not limited to user equipment information, user personal information, and the like) and data (including but not limited to data for analysis, stored data, displayed data, and the like) involved in the present disclosure are all authorized by the user or information and data fully authorized by all parties. The collection, use, and processing of relevant data need to conform to relevant laws, regulations, and standards of relevant countries and regions, and provide corresponding operation portals for the user to choose to authorize or refuse.

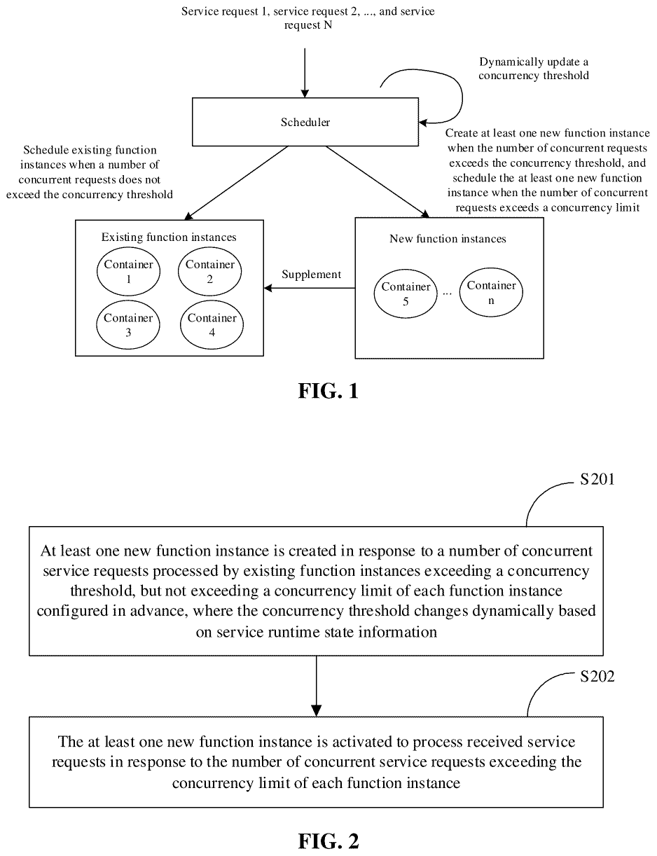

FIG. 1 is a schematic diagram of an application scenario of a technical solution of the present disclosure. A serverless platform provides computing services for users through function instances. After receiving a service request sent from a user side, the serverless platform schedules a function instance through a scheduler, so as to process the service request, thereby meeting a service requirements of the user. The function instance is a computing instance obtained by performing instantiation processing on a function template, and the function instance implements a computing service through a computing resource (a central processing unit (CPU) resource, a memory resource, or the like). A container provides a computing environment for the function instance, and each function instance corresponds to one container. A concurrency limit of each function instance refers to a maximum number of service requests that a single function instance can process concurrently. When the number of concurrent service requests processed by the single instance exceeds the concurrency limit, a new service request is to be sent to another function instance that has not reached the concurrency limit. The concurrency limit of the function instance is configured by the user side based on specific service requirements, or is pre-configured by the serverless platform based on user requirements. The concurrency threshold is dynamically updated based on service runtime state information, and the concurrency threshold is less than the concurrency limit.

As shown in FIG. 1, the scheduler receives a service request sent from the user side, such as a service request 1, a service request 2, . . . , and a service request N shown in FIG. 1. When an average number of concurrent service requests processed by the existing function instances does not exceed the concurrency threshold, the scheduler schedules the existing function instances (such as the function instances respectively corresponding to a container 1, a container 2, a container 3, and a container 4 shown in FIG. 1) to process the service requests. When the average number of concurrent service requests exceeds the concurrency threshold, new function instances are created (such as function instances respectively corresponding to a container 5, . . . , and a container n shown in FIG. 1). The newly created function instances are not immediately activated. When the average number of concurrent service requests exceeds the concurrency limit, the at least one new function instance is activated to process the received service requests. The at least one new function instance serves as a supplement to the existing function instances. During a cold start of each function instance, the following steps are performed: steps of image or code package downloading, code package decompression, service function initialization logic, and the like. A larger image or code package and more complex service function initialization logic lead to a longer time period of the cold start. In some embodiments, since the at least one new function instance is created before the concurrency limit of each function instance is exceeded, it is equivalent to preheating the function instances, which can reduce a time delay of the cold start. When the number of concurrent service requests does not exceed the concurrency limit, the at least one new function instance is not activated, thereby improving resource utilization and avoiding a waste of resources without increasing user costs.

In the related art, a delay problem caused by the cold start is avoided in the following manners:

(1) Resident reserved function instances, that is, a fixed number of function instances. The user may set a minimum number of reserved function instances based on service requirements. When the user expects to avoid the cold start through this scheme, a relatively large number of redundant instances often need to be set.

The disadvantage of this processing manner is that a serious waste of resources may be easily caused, and full resource fees still need to be paid during off-peak service times, which increases costs.

(2) Horizontal Pod Autoscaler (HPA). It is a scheme for container cluster management systems (for example, Kubernetes) to automatically scale container groups based on workload. A threshold reached by a workload resource (for example, a CPU, a MEM, or a custom metric) is configured based on the HPA on the user side. When the load resource increases and exceeds a configured threshold, and a number of container groups (Pods) is less than a configured maximum value, the workload resource is upscaled. The disadvantage of this processing manner is lack of real-time performance of scaling metrics. The scaling through the HPA generally has a delay of 15s to 20s. Moreover, a traffic pulse scenario may lead to a severe shortage of existing computing resources. In addition, elastic scaling is triggered only when a service peak is reached. Otherwise, elastic triggering is relatively delayed.

(3) Scheduled scaling. This allows a user to set a number of elastic function instances required for each time period, and the user may adjust resources in each time period based on service requirements. The disadvantage of this processing manner is that the user needs to manually set the number of function instances in each time period. An excessively large number of function instances easily causes a waste of resources, and an excessively small number of function instances cannot meet actual requirements. Moreover, a timing strategy needs to be adjusted based on service changes, and usability is poor.

(4) Advanced Horizontal Pod Autoscaler (AHPA), also referred to as elastic prediction, supports automatic identification of scaling cycles and capacity forecasting based on historical service metrics, enabling proactive elastic planning. The disadvantage of this manner is that in the face of unexpected traffic, lack of historical data prevents proactive elastic planning, resulting in a problem of a lag of elastic triggering by the HPA.

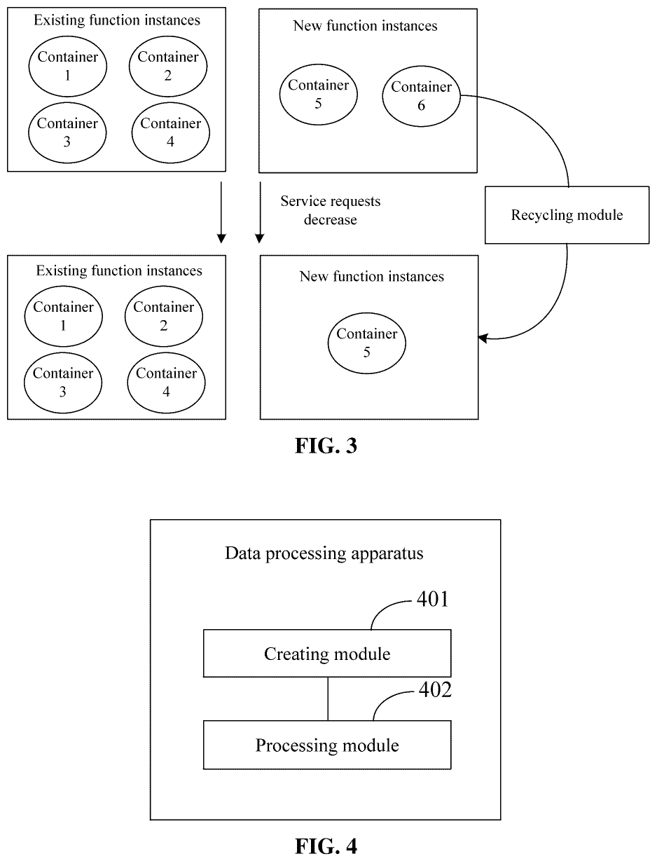

Some embodiments of the present disclosure provide a data processing method. The data processing method in some embodiments is applied to a computing device. The computing device includes a server, and the like. As shown in FIG. 2, FIG. 2 is a flowchart of a data processing method according to some embodiments of the present disclosure. The data processing method includes the following steps.

In step S201, at least one new function instance is created in response to a number of concurrent service requests processed by existing function instances exceeding a concurrency threshold, but not exceeding a concurrency limit of each function instance configured in advance, where the concurrency threshold changes dynamically based on service runtime state information.

In step S202, the at least one new function instance is activated to process received service requests in response to the number of concurrent service requests exceeding the concurrency limit of each function instance.

The function instance is a computing instance obtained by performing instantiation processing on a function template, and the function instance implements a computing service through a computing resource (a central processing unit resource, a memory resource, or the like). A container is used for providing a computing environment for the function instance.

The number of existing function instances is at least one. When the number of existing function instances is greater than one, the number of concurrent service requests of the existing function instances is an average number of concurrent service requests of multiple function instances. A concurrency limit of a function instance refers to a maximum number of service requests that a single function instance can process concurrently. When the number of concurrent service requests processed by the single function instance exceeds the concurrency limit, a new service request is to be sent to another function instance that has not reached the concurrency limit. The concurrency limit of the function instance is configured by the user side based on specific service requirements, or is pre-configured based on user requirements. The concurrency threshold is dynamically updated based on service runtime state information, and the concurrency threshold is less than the concurrency limit.

In some examples, the user side configures an instance specification of a function instance based on a service requirement, that is, a CPU resource, a memory resource, and the like that the function instance can use. Moreover, the user side configures a concurrency limit of the function instance and a required number of function instances. The configured number of function instances may play the role of rate limiting for protection, and computing resource utilization may be evaluated based on the configuration. The serverless platform configures, based on instance specifications and concurrency limits of function instances configured by the user and the number of function instances, function instances that meet user requirements for the user, so as to provide computing services. In addition, the serverless platform configures a concurrency threshold and dynamically updates the concurrency threshold based on service running status during service running. When the average number of concurrent service requests processed by a function instance exceeds the concurrency threshold, at least one new function instance is created. When the number of concurrent service requests exceeds the concurrency limit, the at least one new function instance is activated to process the received service request.

According to the data processing method provided in embodiments of the present disclosure, first, the at least one new function instance is created in response to a number of concurrent service requests processed by existing function instances exceeding a concurrency threshold, but not exceeding a concurrency limit of each function instance configured in advance, where the concurrency threshold changes dynamically based on service runtime state information. Then the at least one new function instance is activated to process received service requests in response to the number of concurrent service requests exceeding the concurrency limit of each function instance. In the embodiments of the present disclosure, when the number of concurrent service requests processed by the existing function instances exceeds the concurrency threshold, the at least one new function instance is created, thereby reducing delay caused by cold start of the function instances. The at least one new function instance is not activated immediately once the at least one new function instance has been created, but is activated when the number of concurrent service requests exceeds the concurrency limit of each function instance configured in advance, so as to avoid waste of resources and prevent additional costs for users.

A difference between the concurrency threshold and the concurrency limit is a buffer zone for the cold start of the function instance. The concurrency threshold changes dynamically based on service runtime state information. When the number of concurrent service requests exceeds the concurrency threshold, at least one new function instance is created to implement proactive upscaling, so that an upscaling delay caused by service side preparation function instances or user function instance startup logic may be reduced. Therefore, how to dynamically update the concurrency threshold based on the service runtime state information is specifically shown in the following embodiments.

In some embodiments, before creating at least one new function instance, the data processing method further includes the following steps. The concurrency threshold is determined based on a function instance scaling impact factor contained in the service runtime state information, where the function instance scaling impact factor includes at least one of the following: change information of queries per second (QPS) of service traffic; change information of an end-to-end reaction time (RT); a duration execution time of each function instance; and load change information of each function instance.

In an actual application, a calculation rule of the concurrency threshold is designed based on the following factors: a change of QPS of service traffic may be used as one of the factors to predict whether the function instance needs to be scaled. A greater growth slope of service traffic leads to a smaller concurrency threshold, so as to trigger rapid upscaling. The change information of the end-to-end RT may be used as one of the factors to predict that a function instance is about to be upscaled. A more rapid increase in the RT leads to a smaller concurrency threshold to be set. The duration of execution of the function instance may be used as one of the factors to predict that the function instance is about to be upscaled. A more rapid increase in the duration of execution of the function leads to a smaller concurrency threshold to be set. The load of the function instance includes a CPU usage rate, a memory usage rate, network traffic, and the like. A more rapid increase in the load leads to a smaller concurrency threshold to be set.

In some examples, the concurrency threshold of the function instances may be found through a local optimal search algorithm, for example, a hill climbing algorithm or a simulated annealing algorithm, based on the current average number of concurrent service requests of multiple function instances, and at least one of the foregoing multiple impact factors.

In some embodiments, before creating at least one new function instance, the data processing method further includes the following steps. The concurrency threshold is determined based on a function instance cold start cost factor contained in the service runtime state information, where the function instance cold start cost factor includes at least one of the following: a container image preparation delay of each function instance; a function code package download and decompression delay; and a service cold start delay.

In an actual application, the calculation rule of the concurrency threshold may be designed based on the following factors. A container image download delay may be used as one of the factors to predict that the function instance needs to be upscaled. The concurrency threshold for the first cold start of an image should be less than a concurrency threshold after all subsequent images are created. The function code package download and decompression time may be used as one of the factors to predict that the function instance is about to be upscaled. A concurrency threshold for the first code package download should be less than a concurrency threshold after all subsequent code packages are downloaded. The service cold start delay may be used as one of the factors to predict that the function instance needs to be upscaled. After the function instance is activated, initialization logic configured by the user is executed, and a function call is triggered only after the initialization succeeds, which belongs to the cold start logic on the service side. The service cold start time of the function instance is not necessarily fixed, and may be affected by a downstream function or a service logic branch where the function is activated. A shorter service cold start time of the function instance leads to a concurrency threshold that may be set as similar as possible to the concurrency limit.

In some optional embodiments, the factors related to the dynamic change of the concurrency threshold mainly include cold start cost and the factors that may bring instance scaling requirements. The factors related to the dynamic change of the concurrency threshold are shown in Table 1.

TABLE 1

| | | Detailed definition of | |
|---|---|---|---|
| | Category | relevant factors | Description |
| Container image | System | Container image | In a case that the remaining factors remain |
| preparation delay | cold start | download delay | unchanged, the concurrency threshold for the |
| | | | first cold start of an image should be less than |
| | | | a concurrency threshold after all subsequent |
| | | | images are created (preheated). |
| Code package | | Function code | In a case that the remaining factors remain |
| download and | | package download | unchanged, a concurrency threshold for the |
| decompression | | and decompression | first code package download should be less |
| delay | | time | than a concurrency threshold after all |
| | | | subsequent code packages are downloaded. |
| Runtime server | | The time when the | The start delay of RuntimeServer is basically |
| (RuntimeServer) | | Server starts | fixed, and therefore has little impact on the |
| start delay | | monitoring after the | dynamic change of the concurrency threshold |
| | | Runtime starts | |
| Network card | | Each function instance | |
| preparation delay | | is to configure | |
| of function | | corresponding | |
| instances | | network information | |
| | | for the function | |
| | | container in the | |
| | | creation phase, | |
| | | including network card | |
| | | preparation and | |
| | | network card | |
| | | insertion/removal | |
| | | delay | |
| Service cold start | Instance | After the function | The service cold start time of the function |
| | cold start | instance is activated, | instance is not necessarily fixed, and may be |
| | (service) | the initialization logic | affected by a downstream function or a service |
| | | configured by the user | logic branch where the function is activated. A |
| | | is to be executed. The | shorter service cold start time of the function |
| | | function call is | instance leads to a concurrency threshold that |
| | | triggered only after the | may be set as similar as possible to the |
| | | initialization succeeds, | concurrency limit. |
| | | which belongs to the | |
| | | cold start logic on the | |
| | | service side. | |
| Service traffic | Instance | Change of QPS of | The change of service traffic may be used as |
| change | scaling | service traffic | one of the factors to predict whether the |
| | impact | | instance needs to be scaled. A greater growth |
| | factor | | slope of service traffic leads to a smaller |
| | | | concurrency threshold, so as to trigger rapid |
| | | | upscaling. |
| End-to-end RT | | End-to-end RT delay | An increase in the RT delay may be used as |
| change | | change | one of the factors to predict that an instance is |
| | | | about to be upscaled. A more rapid increase in |
| | | | the RT delay leads to a smaller concurrency |
| | | | threshold to be set. |
| Duration of | | The function execution | The duration of execution of the function may |
| execution of the | | time change may be | be used as one of the factors to predict that |
| function | | related to downstream, | the instance is about to be upscaled. A more |
| | | service logic, input, | rapid increase in the duration of execution of |
| | | and instance load. | the function instance leads to a smaller |
| | | | concurrency threshold to be set. |
| Instance load | | The instance load | The instance load may be used as one of the |
| (CPU, IO, MEM) | | changes, and the load | factors to predict that an instance is about to |
| change | | includes: a CPU usage | be upscaled. A more rapid increase in the |
| | | rate, a memory usage | instance load leads to a smaller concurrency |
| | | rate, network traffic, | threshold to be set. The CPU usage rate in the |
| | | and the like. | instance load may be used as one of the rate |
| | | | limiting factors. For example, when the CPU |
| | | | usage rate of a function instance reaches 80%, |
| | | | even when the number of concurrent service |
| | | | requests of a single instance does not reach |
| | | | the concurrency limit, service requests are no |
| | | | longer scheduled to this function instance. In |
| | | | addition, the load change may further be |
| | | | determined by combining HPA with service |
| | | | request scheduling. |

Table 1 includes factors that require key attention, selective attention, and no attention for the dynamic update of the concurrency threshold.

The indicators that require real-time key attention for dynamic perception of the concurrency threshold have the following characteristics:
1. Changes in the relevant indicators may be obtained in real time, with a high sampling frequency.
2. The changes in the relevant indicators may be used as input to more clearly predict whether upscaling is needed subsequently.

The indicators that require real-time key attention and meet the above characteristics include: a service traffic QPS change, an end-to-end RT change, a duration execution time of a function, an instance load (CPU, IO, MEM) change.

The indicators that require selective attention for the dynamic perception of the concurrency threshold have the following characteristics:
1. An obtaining cycle of the change of the relevant indicators is relatively long.
2. The relevant indicators are unstable, and a great difference between the indicators obtained twice may exist.

Indicators that require selective attention and meet the above characteristics include: a container image preparation delay, a code package download and decompression delay, and a service cold start delay.

Indicators that may temporarily not require attention for dynamic perception of the concurrency threshold have the following characteristics:
the changes in relevant indicators are not significant, and values are relatively fixed in multiple samplings.

Indicators that meet the above characteristics include: a service runtime (Runtime Server) startup delay and a network card preparation delay of a function instance.

In addition, before at least one new function instance is created, it is necessary to determine the number of newly created function instances. Refer to the following embodiments for details.

In some embodiments, the number of existing function instances is greater than one, and before creating at least one new function instance, the data processing method further includes the following steps. Division calculation is performed between a sum of the number of concurrent service requests processed by the existing function instances and the concurrency threshold, and an expected number of function instances is determined based on a calculation result. A difference between the expected number of function instances and the number of existing function instances is determined as the number of the at least one new function instance.

In an actual application, when the number of existing function instances is greater than one, the expected number of function instances, that is, the number of function instances currently needed, may be calculated based on two indicators: a sum of current the number of concurrent service requests processed by the existing function instances and the concurrency threshold calculated based on dynamic perception.

In some examples, the expected number of function instances is calculated based on the following Equation (1):

Expected number of function instances=Ceiling(SUM(number of concurrent service requests of function instances)/concurrency threshold of function instances) (1)

SUM (number of concurrent service requests of function instances) indicates the sum of current the number of concurrent service requests processed by the existing function instances, and Ceiling ( ) indicates a rounding function.

After the expected number of function instances is obtained, a difference between the expected number of function instances and the number of existing function instances is calculated to obtain the number of the at least one new function instance.

Regarding the billing of function instances, billing models of most serverless platforms perform billing based on the usage time of the function instances. Therefore, the upscaled function instances immediately undertake traffic, which may result in an increase in the fees borne by users in case of the same traffic. In some embodiments, the users do not need to perceive the concurrency threshold, and the users do not need to bear the cost since the at least one new function instance is to be created and is not immediately activated when the average number of concurrent service requests exceeds the concurrency threshold. When the number of concurrent service requests exceeds the concurrency limit, the created function instance is activated, and billing starts. This reduces the cold start delay of the function instance without increasing the user cost. In an actual application, in order to avoid a waste of computing resources and prevent the serverless platform from bearing excessive costs, the upscaled function instances may be retained for a period of time and then downscaled at an appropriate time. Refer to the following embodiments for details.

In some embodiments, the data processing method further includes the following steps. The concurrency threshold is updated periodically based on a preset time cycle, and the expected number of function instances is determined based on the updated concurrency threshold. Unused function instances are deleted in response to a number of current function instances being greater than the updated expected number of function instances.

The concurrency threshold is dynamically updated as the running status changes. With the change of the concurrency threshold, the expected number of function instances is dynamically updated. When the number of existing function instances exceeds the required number of function instances, downscaling processing is performed, and the currently unused function instance is deleted to avoid a waste of computing resources.

In some examples, FIG. 3 is a schematic diagram of downscaling function instances. As shown in FIG. 3, each container corresponds to one function instance, which provides a computing environment for the function instance. An expected number of function instances is calculated to be six based on a sum of the number of concurrent service requests of existing function instances and a concurrency threshold. The number of existing function instances is four. When an average number of concurrent service requests of the function instances exceeds the concurrency threshold, two new function instances are created. The concurrency threshold is dynamically updated. When service requests decrease, the expected number of function instances is recalculated to be five, and a currently unused function instance is deleted. As shown in FIG. 3, a function instance corresponding to a container 6 is deleted through a recycling module. The recycling module may be an interface module GC module of a Python garbage collection mechanism.

In some embodiments, the data processing method further includes the following steps. the concurrency threshold is continuously updated within a preset time period after deleting the unused function instances, and the at least one new function instance is created in response to a difference between the concurrency threshold that triggers deletion of the unused function instances and the updated concurrency threshold being less than a preset threshold.

In an actual application, after the function instance is deleted, a period of time is set as an upscaling cooing period, so as to avoid triggering upscaling again after destruction and destroying again when there is no traffic. During the upscaling-out cooing period, the concurrency threshold continues to be dynamically updated. When the calculated concurrency threshold (namely the difference between the concurrency threshold that triggers deletion of the unused function instances and the updated concurrency threshold) is far less than the concurrency threshold that triggers the deletion of the function instance (namely the preset threshold), upscaling is re-triggered to create at least one new function instance.

In some embodiments, the number of existing function instances is greater than one, and the data processing method further includes the following steps. For any existing function instance, in response to the number of concurrent service requests processed by this function instance not exceeding the concurrency limit of a current function instance, and a utilization rate of a central processing unit of the current function instance exceeding a preset utilization threshold, received service requests are distributed to function instances other than the current function instance for processing.

In an actual application, when it is determined that which function instances are called to process services, in addition to considering whether the number of concurrent service requests of the function instances exceeds the concurrency limit, it is also necessary to consider whether the CPU utilization of the function instances exceeds a preset utilization threshold. When the CPU utilization exceeds the preset utilization threshold, it indicates that a health status of the function instance does not meet requirements. To ensure service quality, even if the number of concurrent service requests of the function instance does not exceed the concurrency limit, the function instance is not used, and other healthy function instances are selected to process the service request.

Corresponding to the application scenario of the data processing method provided in the embodiments of the present disclosure, some embodiments of the present disclosure further provide a data processing apparatus. As shown in FIG. 4, FIG. 4 is a structural block diagram of a data processing apparatus according to some embodiments of the present disclosure. The apparatus includes:
a creating module 401, configured to create at least one new function instance in response to a number of concurrent service requests processed by existing function instances exceeding a concurrency threshold, but not exceeding a concurrency limit of each function instance configured in advance, where the concurrency threshold changes dynamically based on service runtime state information; and
a processing module 402, configured to activate the at least one new function instance to process received service requests in response to the number of concurrent service requests exceeding the concurrency limit of each function instance.

According to the data processing apparatus provided in embodiments of the present disclosure, first, the at least one new function instance is created in response to a number of concurrent service requests processed by existing function instances exceeding a concurrency threshold, but not exceeding a concurrency limit of each function instance configured in advance, where the concurrency threshold changes dynamically based on service runtime state information. Then the at least one new function instance is activated to process received service requests in response to the number of concurrent service requests exceeding the concurrency limit of each function instance. In the embodiments of the present disclosure, when the number of concurrent service requests processed by the existing function instances exceeds the concurrency threshold, the at least one new function instance is created, thereby reducing delay caused by cold start of the function instances. The at least one new function instance is not activated immediately once the at least one new function instance has been created, but is activated when the number of concurrent service requests exceeds the concurrency limit of each function instance configured in advance, so as to avoid waste of resources and prevent additional costs for users.

In some embodiments, the data processing apparatus is further configured to: determine the concurrency threshold based on a function instance scaling impact factor contained in the service runtime state information; and the function instance scaling impact factor includes at least one of the following: change information of queries per second of service traffic; change information of an end-to-end reaction time; a duration execution time of each function instance; and load change information of each function instance.

In some embodiments, the data processing apparatus is further configured to: determine the concurrency threshold based on a function instance cold start cost factor contained in the service runtime state information; and the function instance cold start cost factor includes at least one of the following: a container image preparation delay of each function instance; a function code package download and decompression delay; and a service cold start delay.

In some embodiments, the number of existing function instances is greater than one. The data processing apparatus is further configured to: perform division calculation between a sum of the number of concurrent service requests processed by the existing function instances and the concurrency threshold, and determining an expected number of function instances based on a calculation result; and determine a difference between the expected number of function instances and the number of existing function instances as the number of the at least one new function instance.

In some embodiments, the data processing apparatus is further configured to: update the concurrency threshold periodically based on a preset time cycle, and determining an expected number of function instances based on the updated concurrency threshold; and delete unused function instances in response to a number of current function instances being greater than the updated expected number of function instances.

In some embodiments, the data processing apparatus is further configured to: continuously update the concurrency threshold within a preset time period after deleting the unused function instances, and create the at least one new function instance in response to a difference between the concurrency threshold that triggers deletion of the unused function instances and the updated concurrency threshold being less than a preset threshold.

In some embodiments, the number of existing function instances is greater than one. The data processing apparatus is further configured to: for any existing function instance, in response to the number of concurrent service requests processed by this function instance not exceeding the concurrency limit of a current function instance, and a utilization rate of a central processing unit of the current function instance exceeding a preset utilization threshold, distribute received service requests to function instances other than the current function instance for processing.

For the functions of the modules in the apparatuses of the embodiments of the present disclosure, reference may be made to the corresponding descriptions in the above method, and the functions have corresponding beneficial effects. Details are not described herein again.

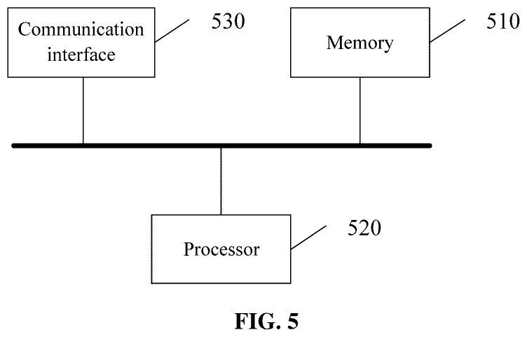

FIG. 5 is a block diagram of an electronic device for implementing some embodiments of the present disclosure. As shown in FIG. 5, the electronic device includes a memory 510 and a processor 520. The memory 510 stores a computer program executable on the processor 520. The processor 520 implements the data processing method in the foregoing embodiments when executing the computer program. At least one memory 510 and processor 520 may be arranged.

The electronic device further includes
a communication interface 530, configured to communicate with an external device and perform data exchange and transmission.

When the memory 510, the processor 520, and the communication interface 530 are implemented independently, the memory 510, the processor 520, and the communication interface 530 may be connected with each other through a bus and communicate with each other. The bus may be an industry standard architecture (ISA) bus, a peripheral component interconnect (PCI) bus, an extended industry standard architecture (EISA) bus, or the like. The bus may be classified as an address bus, a data bus, a control bus, and the like. For ease of representation, one bold line is used for representing the bus in FIG. 5, which does not mean that only one bus or only one type of bus is provided.

Optionally, in a specific implementation, when the memory 510, the processor 520, and the communication interface 530 are integrated on a chip, the memory 510, the processor 520, and the communication interface 530 may complete communication with each other through an internal interface.

Some embodiments of the present disclosure provide a computer-readable storage medium storing a computer program. When the program is executed by a processor, the data processing method provided in the embodiments of the present disclosure is implemented.

Some embodiments of the present disclosure further provide a chip. The chip includes a processor, configured to invoke an instruction from a memory and run the instruction stored in the memory, so that a communication device having the chip installed therein performs the data processing method provided in the embodiments of the present disclosure.

Some embodiments of the present disclosure further provide a chip, including: an input interface, an output interface, a processor, and a memory. The input interface, the output interface, the processor, and the memory are connected through internal connection paths. The processor is configured to execute code in the memory. When the code is executed, the processor is configured to perform the data processing method provided in the embodiments of the present disclosure.

It should be understood that the foregoing processor may be a central processing unit (CPU), and may further be another general-purpose processor, a digital signal processor (DSP), an application specific integrated circuit (ASIC), a field programmable gate array (FPGA) or another programmable logic device, a discrete gate or a transistor logic device, a discrete hardware component, or the like. The general-purpose processor may be a microprocessor, any conventional processor, or the like. It is worth noting that the processor may be a processor supporting an advanced RISC machines (ARM) architecture.

Furthermore, optionally, the foregoing memory may include a read-only memory and a random access memory. The memory may be a volatile memory or a non-volatile memory, or may include both a volatile memory and a non-volatile memory. The non-volatile memory may include a read-only memory (ROM), a programmable ROM (PROM), an erasable PROM (EPROM), an electrically EPROM (EEPROM), or a flash memory. The volatile memory may include a random access memory (RAM) that is used as an external cache. Through examples but not limitation, many forms of RAM are available. For example, a static RAM (SRAM), a dynamic RAM (DRAM), a synchronous DRAM (Synchronous DRAM, SDRAM), a double data rate SDRAM (DDR SDRAM), an enhanced SDRAM (ESDRAM), a synchlink DRAM (SLDRAM), and a direct rambus RAM (DR RAM).

All or some of the above embodiments may be implemented through software, hardware, firmware, or any combination thereof. During implementation through software, all or some of the embodiments may be implemented in a form of a computer program product. The computer program product includes at least one computer instruction. When the at least one computer program instruction is loaded and executed on a computer, the processes or functions according to the present disclosure are generated in whole or in part. The computer may be a general-purpose computer, a dedicated computer, a computer network, or another programmable apparatus. The computer instruction may be stored in a computer-readable storage medium, or may be transmitted from one computer-readable storage medium to another computer-readable storage medium.

In the descriptions of this specification, a description with reference to a term such as “an embodiment”, “some embodiments”, “an example”, “a specific example”, or “some examples” means that specific features, structures, materials, or characteristics described with reference to the embodiment or the example are included in at least one embodiment or example of the present disclosure. Moreover, the specific features, structures, materials, or characteristics described may be combined in a proper manner in any at least one embodiments or example. In addition, a person having ordinary skill in the art may integrate or combine different embodiments or examples described in the specification and features of the different embodiments or examples as long as they are not contradictory to each other.

In addition, terms “first” and “second” are used for the purpose of description, and cannot be understood as indicating or implying relative importance or implying a number of indicated technical features. Therefore, features defined with “first” and “second” may explicitly or implicitly include at least one of the features. In the description of the present disclosure, “multiple” means two or more, unless otherwise explicitly and specifically defined.

A description of any process or method in the flowcharts or described herein in another manner may be understood as representing at least one module, at least one fragment, or at least one part that includes code of executable instructions for implementing a specific logical function or steps of a process. In addition, the scope of preferred implementations of the present disclosure includes additional implementations, where functions may be performed out of the order shown or discussed, including in a substantially simultaneous manner or in reverse order based on the functions involved.

The logic and/or steps described in the flowcharts or described in another manner herein may be, for example, regarded as a sequence list of executable instructions for implementing logical functions, which may be specifically implemented in any computer-readable medium for use by or in combination with an instruction execution system, an apparatus, or a device (such as a computer-based system, a system including a processor, or another system that may obtain an instruction from the instruction execution system, the apparatus, or the device and execute the instruction).

It should be understood that parts of the present disclosure may be implemented through hardware, software, firmware, or a combination thereof. In the foregoing implementations, multiple steps or methods may be implemented through software or firmware stored in a memory and executed by an appropriate instruction execution system. All or some of the steps of the foregoing method embodiments may be completed by a program instructing relevant hardware. The program may be stored in a computer-readable storage medium. When the program is executed, one or a combination of the steps of the data processing method embodiments are performed.

In addition, each functional unit in each embodiment of the present disclosure may be integrated into one processing module, or each unit may exist alone physically, or two or more units may be integrated into one module. The foregoing integrated module may be implemented in the form of hardware, or may be implemented in a form of a software functional module. When implemented in the form of a software functional module and sold or used as an independent product, the foregoing integrated module may also be stored in a computer-readable storage medium. The storage medium may be a ROM, a magnetic disk, an optical disc, or the like.

The foregoing descriptions are exemplary implementations of the present disclosure, but the protection scope of the present disclosure is not limited thereto. Various variations or replacements readily figured out by a person having ordinary skill in the art within the technical scope recorded in the present disclosure shall fall within the protection scope of the present disclosure. Therefore, the protection scope of the present disclosure shall be subject to the protection scope of the claims.

1. A data processing method, comprising:
creating at least one new function instance in response to a number of concurrent service requests processed by existing function instances exceeding a concurrency threshold, but not exceeding a concurrency limit of each function instance configured in advance, wherein the concurrency threshold changes dynamically based on service runtime state information; and
activating the at least one new function instance to process received service requests in response to the number of concurrent service requests exceeding the concurrency limit of each function instance.

2. The data processing method according to claim 1, wherein before creating the at least one new function instance, the data processing method further comprises:
determining the concurrency threshold based on a function instance scaling impact factor contained in the service runtime state information; and
the function instance scaling impact factor comprises at least one of the following:
change information of queries per second of service traffic; change information of an end-to-end reaction time; a duration execution time of each function instance; and load change information of each function instance.

3. The data processing method according to claim 1, wherein before creating the at least one new function instance, the data processing method further comprises:
determining the concurrency threshold based on a function instance cold start cost factor contained in the service runtime state information; and
the function instance cold start cost factor comprises at least one of the following:
a container image preparation delay of each function instance; a function code package download and decompression delay; and a service cold start delay.

4. The data processing method according to claim 1, wherein the number of existing function instances is greater than one, and before creating the at least one new function instance, the data processing method further comprises:
performing division calculation between a sum of the number of concurrent service requests processed by the existing function instances and the concurrency threshold, and determining an expected number of function instances based on a calculation result; and
determining a difference between the expected number of function instances and the number of existing function instances as the number of the at least one new function instance.

5. The data processing method according to claim 4, further comprising:
updating the concurrency threshold periodically based on a preset time cycle, and determining an expected number of function instances based on the updated concurrency threshold; and
deleting unused function instances in response to a number of current function instances being greater than the updated expected number of function instances.

6. The data processing method according to claim 5, further comprising:
continuously updating the concurrency threshold within a preset time period after deleting the unused function instances, and creating the at least one new function instance in response to a difference between the concurrency threshold that triggers deletion of the unused function instances and the updated concurrency threshold being less than a preset threshold.

7. The data processing method according to claim 1, wherein the number of existing function instances is greater than one, and the data processing method further comprises:
for any existing function instance, in response to the number of concurrent service requests processed by this function instance not exceeding the concurrency limit of a current function instance, and a utilization rate of a central processing unit of the current function instance exceeding a preset utilization threshold, distributing received service requests to function instances other than the current function instance for processing.

8. (canceled)

9. An electronic device, comprising a memory, a processor, and a computer program stored in the memory, wherein the processor implements the following steps when executing the computer program:
creating at least one new function instance in response to a number of concurrent service requests processed by existing function instances exceeding a concurrency threshold, but not exceeding a concurrency limit of each function instance configured in advance, wherein the concurrency threshold changes dynamically based on service runtime state information; and
activating the at least one new function instance to process received service requests in response to the number of concurrent service requests exceeding the concurrency limit of each function instance.

10. A non-transitory storage medium, storing a computer program, the computer program, when executed by a processor, implementing the following steps:
creating at least one new function instance in response to a number of concurrent service requests processed by existing function instances exceeding a concurrency threshold, but not exceeding a concurrency limit of each function instance configured in advance, wherein the concurrency threshold changes dynamically based on service runtime state information; and
activating the at least one new function instance to process received service requests in response to the number of concurrent service requests exceeding the concurrency limit of each function instance.

11. The data processing method according to claim 2, wherein the number of existing function instances is greater than one, and before creating the at least one new function instance, the data processing method further comprises:
performing division calculation between a sum of the number of concurrent service requests processed by the existing function instances and the concurrency threshold, and determining an expected number of function instances based on a calculation result; and
determining a difference between the expected number of function instances and the number of existing function instances as the number of the at least one new function instance.

12. The data processing method according to claim 3, wherein the number of existing function instances is greater than one, and before creating the at least one new function instance, the data processing method further comprises:
performing division calculation between a sum of the number of concurrent service requests processed by the existing function instances and the concurrency threshold, and determining an expected number of function instances based on a calculation result; and
determining a difference between the expected number of function instances and the number of existing function instances as the number of the at least one new function instance.

13. The data processing method according to claim 2, wherein the number of existing function instances is greater than one, and the data processing method further comprises:
for any existing function instance, in response to the number of concurrent service requests processed by this function instance not exceeding the concurrency limit of a current function instance, and a utilization rate of a central processing unit of the current function instance exceeding a preset utilization threshold, distributing received service requests to function instances other than the current function instance for processing.

14. The data processing method according to claim 3, wherein the number of existing function instances is greater than one, and the data processing method further comprises:
for any existing function instance, in response to the number of concurrent service requests processed by this function instance not exceeding the concurrency limit of a current function instance, and a utilization rate of a central processing unit of the current function instance exceeding a preset utilization threshold, distributing received service requests to function instances other than the current function instance for processing.

15. The data processing method according to claim 1, wherein each function instance is a computing instance obtained after instantiating a function template, and implements computing services by utilizing computing resources.

16. The data processing method according to claim 1, wherein the concurrency threshold is less than the concurrency limit of each function instance.

17. The data processing method according to claim 1, wherein in response to the number of existing function instances being greater than one, the concurrency number of existing function instances is an average concurrency number of a plurality of function instances.

18. The data processing method according to claim 1, wherein the concurrency limit of each function instance is a maximum number of service requests concurrently processed by a single function instance.

19. The data processing method according to claim 2, wherein a greater slope of an increase in the service traffic indicates that the concurrency threshold is set to a smaller value.

20. The data processing method according to claim 2, wherein a faster increase in the reaction time indicates that the concurrency threshold is set to a smaller value.

21. The data processing method according to claim 2, wherein a faster increase in a duration execution time indicates that the concurrency threshold is set to a smaller value, and/or a faster increase in load indicates that the concurrency threshold is set to a smaller value.
